(19) United States
(12) Patent Application Publication
(10) Pub. No.: US 2025/0117451 A1
(43) Pub. Date: Apr. 10, 2025

(54) SYSTEMS AND METHODS FOR GENERATING PROTECTED ACCESSIBLE HYPERTEXT MARKUP LANGUAGE (HTML)

(71) Applicant: Capital One Services, LLC, McLean, VA (US)

(72) Inventors: Matthew HUNSBERGER, Hoboken, NJ (US); Tyler MAIMAN, Melville, NY (US); Joshua EDWARDS, Philadelphia, PA (US); Ian KATZMAN, Herndon, VA (US); Shahalam BAIG, Rochester, NY (US); Jackson WESTWOOD, New York, NY (US); Shasanka BHANDARI, McLean, VA (US)

(73) Assignee: Capital One Services, LLC, McLean, VA (US)

(21) Appl. No.: 18/905,243

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 3/0484

(52) U.S. Cl. CPC G06F 21/101; G06F 3/0484

(57) ABSTRACT

Described are systems and methods for generating protected accessible HyperText Markup Language (“HTML”), the method including receiving a request to load media content associated with a first HTML element, upon receiving the request to load the content element, generating video data associated with the content element, generating one or more digital rights management-protected files based on the video data associated with the content element, generating a second HTML element based on the one or more DRM-protected files, and causing to output, via a graphical user interface, the digital rights management-protected video data of the second HTML element.

### CROSS-REFERENCE TO RELATED APPLICATION(S)

This application claims the benefit of pending U.S. Provisional Patent Application No. 63/587,891, filed on Oct. 4, 2023, U.S. Provisional Patent Application No. 63/665,485, filed on Jun. 28, 2024, and U.S. Provisional Patent Application No. 63/683,063, filed on Aug. 14, 2024, all of which are incorporated herein by reference in their entireties.

### TECHNICAL FIELD

Various embodiments of this disclosure relate generally to generating protected accessible hypertext markup language (“HTML”) and, more particularly, to systems and methods for generating protected accessible HTML to generate protected video, text, or audio.

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may persuade the user to reveal the account number to the social engineer. More specifically, the social engineer may convince the user to share the user's screen displaying the account number with the social engineer, using a screensharing or remote desktop application. In addition or in the alternative, the social engineer may convince the user to take a screenshot of the user's screen displaying the account number, using a screenshotting application, and then transmit the screenshot to the social engineer.

To guard against such social engineering, the bank may employ digital rights management (“DRM”) technologies, which are technologies that limit the use of digital content. For example, the bank may protect sensitive text data using DRM technologies. However, accessibility data may not be protected.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for generating protected HTML.

In one aspect, a method for generating protected accessible HyperText Markup Language (“HTML”) is disclosed. The method may include receiving a request to load media content associated with a first HTML element, the first HTML element including a content element, upon receiving the request to load the content element, generating video data associated with the content element, generating one or more digital rights management (“DRM”)-protected files based on the video data associated with the content element, wherein at least one of the one or more DRM-protected files includes the video data associated with the content element, generating a second HTML element based on the one or more DRM-protected files, wherein the second HTML element includes DRM-protected video data associated with the content element, and causing to output, via a graphical user interface (“GUI”), the DRM-protected video data of the second HTML element.

In another aspect, a system is disclosed. The system may include at least one memory storing instructions, and at least one processor operatively connected to the memory, and configured to execute the instructions to perform operations for generating protected accessible HTML. The operations may include receiving a request to load media content associated with a first HTML element, the first HTML element including a content element, upon receiving the request to load the content element, generating video data associated with the content element, generating one or more DRM-protected files based on the video data associated with the content element, wherein at least one of the one or more DRM-protected files includes the video data associated with the content element, generating a second HTML element based on the one or more DRM-protected files, wherein the second HTML element includes DRM-protected video data associated with the content element, and causing to output, via a GUI, the DRM-protected video data of the second HTML element.

In another aspect, a method for generating protected accessible HTML is disclosed. The method may include receiving a request to load media content associated with a first HTML element, the first HTML element including a content element, upon receiving the request to load the content element, generating at least one of video data, text data, or audio data associated with the content element, generating one or more DRM-protected files based on the at least one of video data, text data, or audio data associated with the content element, wherein at least one of the one or more DRM-protected files includes the at least one of video data, text data, or audio data associated with the content element, generating a second HTML element based on the one or more DRM-protected files, wherein the second HTML element includes DRM-protected video data associated with the content element, generating a third HTML element based on the one or more DRM-protected files, wherein the third HTML element includes DRM-protected text data associated with the content element, generating a fourth HTML element based on the one or more DRM-protected files, wherein the fourth HTML element includes DRM-protected audio data associated with the content element, generating a nested HTML element based on the one or more DRM-protected files, wherein the nested HTML element includes the first HTML element and at least one of the second HTML element, the third HTML element, or the fourth HTML element, and causing to output, via a GUI or an auditory interface system, the DRM-protected data of the nested HTML element.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for generating protected accessible Hypertext Markup Language (“HTML”), according to one or more embodiments.

FIGS. 2A-2D depict an exemplary method for generating protected accessible HTML, according to one or more embodiments.

FIG. 3 depicts a simplified functional block diagram of a computer, according to one or more embodiments.

### DETAILED DESCRIPTION OF EMBODIMENTS

Reference to any particular activity is provided in this disclosure only for

convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if”' is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “user” or the like may refer to a person authorized to access an account, attempting to access an account, etc. As used herein, the term “social engineer” may be a person or entity who seeks to manipulate a target (e.g., a customer or employee of an organization) into divulging sensitive information that may be used for fraudulent purposes. That is, a social engineer is a person or entity who engages in social engineering.

The term “channel” or the like may refer to a pathway or stream through which data flows from one place to another. A channel may separate different types of data, such as audio, video, or effects. Each channel may be edited or manipulated independently.

The phrase “hypertext markup language,” “HTML,” or the like may refer to a standardized system for tagging text files to achieve font, color, graphic, or hyperlink effects on World Wide Web pages. The phrase “HTML element” may represent a component of an HTML page, and may include, for example, a start tag and end tag, and as noted above, a content element or a reference to a content element (e.g., link, hyperlink, address, or path to a content element). Further, in some embodiments, an HTML element may include one or more HTML elements (e.g., nested HTML elements). As used herein, the term “pixel” may refer to the smallest element (or unit) of a display screen that can be programmed by (or manipulated through) software. In some embodiments, a pixel may include sub-pixels (e.g., a red sub-pixel, a green sub-pixel, and a blue sub-pixel) that emit light to create a color displayed on the display screen. In some aspects, the color may be included in, or represent, text data, image data, or video data presented on the display screen.

As used herein, the term “electronic document,” “document,” or “content object” may refer to an electronic file (also referred to herein as a “file”) that includes text data, image data, audio data (e.g., a sequence of audio frames), video data (e.g., a sequence of image frames or video frames), or other data, and that is not programmed (or written) in HTML. A document may represent, for example, a text document (e.g., a Microsoft Word document, a plain text file, or the like), a spreadsheet (e.g., a Microsoft Excel file, a comma-separated values file, or the like), a presentation, slides, or slide deck (e.g., a Microsoft PowerPoint file or the like), a PDF file, an image document (e.g., a Joint Photographic Experts Group (“JPEG”) file, a Portable Network Graphics (“PNG”) file, a Graphics Interchange Format (“GIF”) file, a Scalable Vector Graphics (“SVG”) file, or the like), a multimedia file (e.g., a file that includes text data and one or more of image data, audio data, or video data), or the like. In some embodiments, a document may include one or more content elements (or represent a single content element).

As used herein, the phrase “content element” may represent text data, image data, audio data (e.g., a sequence of audio frames), or video data (e.g., a sequence of image frames). A content element may be included in HTML used to structure the website, such as a Document Object Model (“DOM”). In some aspects, the content element may include or represent sensitive or confidential information (e.g., that may be displayed on a webpage (or webpage(s), website(s), portal(s) or application(s), etc.). As used herein, the phrase “sensitive information” may include personally identifiable information (“PII”) (e.g., a name, an address, a phone number, a social security number, etc.), financial information (e.g., an account number, an account balance, debits, credits, etc.), medical information (e.g., test results, appointments, medications, etc.), business information (e.g., proprietary information, trade secrets, etc.), government information (e.g., classified or secret information), any information a user may wish to not be shared with a third party, etc.

As used herein, the phrase “digital extraction” may refer to any process of copying content (e.g., audio, video, text, image, etc.), such as ripping, screensharing, screenshotting, etc. As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad).

According to an example of the disclosed subject matter, a user (e.g., a person) who is visually impaired may wish to know the balance of the user's savings account using a braille display associated with a screen reader, which is a technology used to render digital text or digital images as audible speech or braille output. The user may access a computing device on which the system described herein may operate. For example, the computing device may include the browser module in communication with the screen reader. In some embodiments, the browser module or the screen reader may be in communication with a braille display. The user may use the browser module and the screen reader to navigate to a website through which the savings account number (e.g., the content element of the first HTML element) may be accessed.

When the website is loading, the system may generate, using an application server, one or more DRM-protected files that include video data, audio data, or text data. In some aspects, each of the video, audio data, or text data may be associated with the savings account number (or content element) (e.g., the sensitive information).

The system may further form, using the browser module or the application server, a second HTML element, which may include a video of the one or more DRM-protected files (e.g., the DRM-protected video). The system may further output the video and the user's savings account number to the display screen, such that the video is overlaid on the user's savings account number. The video may be a single frame-looped video that may be representative of the savings account number. In some embodiments, where the user is not screen-sharing their screen, the video may not be displayed (e.g., may not be caused to be output). However, if the user shares their screen or takes a screenshot of the screen, the video may be caused to be displayed. In some embodiments, where the user is not screen-sharing their screen, the video may be displayed as a transparent video and be played on top of the savings account number. However, if the user shares their screen or takes a screenshot of the screen, the DRM-protections of the video may cause the video to stop playing or appear on the display screen as an opaque image to hide the savings account number from a potential social engineer.

Further, the system may form, using the browser module or the application server, a third HTML element, which may include text data from the one or more DRM-protected files (or a metadata channel or a subtitle channel of the one or more DRM-protected files). In some aspects, the text data may be associated with (e.g., represent) the user's savings account number. In some embodiments, while or after the website loads, the screen reader may interpret (e.g., read) the text data of the third HTML element, and use the interpreted text data to cause the braille display to output a representation of the user's savings account number.

According to a further example of the disclosed subject matter, a user (e.g., a person) who is visually impaired may wish to know the balance of the user's savings account using an audio speaker associated with a screen reader. The user may access a computing device on which the system described herein may operate. For example, the computing device may include the browser module in communication with the screen reader. In some embodiments, the browser module or the screen reader may be in communication with the audio speaker. The user may use the browser module and the screen reader to navigate to a website through which the savings account number (e.g., the content element of the first HTML element) may be accessed.

In some embodiments, the system described herein may generate, using the application server, one or more DRM-protected files that include video data, audio data, or text data. The one or more DRM-protected files may be generated before the website loads, simultaneous with the website loading, after the website loads, etc. In some aspects, each of the video, audio data, and text data may be associated with the savings account number (or content element).

The system may further form, using the browser module or the application server, the second HTML element, which may include the video of the one or more DRM-protected files (e.g., the DRM-protected video). The system may further output the video and the user's savings account number to the display screen, as described herein.

Further, the system may form, using the browser module or the application server, a fourth HTML element, which may include audio data from the audio channel of the one or more DRM-protected files. The audio data may be DRM-protected and be associated with the user's savings account number. In some aspects, the audio data of the fourth HTML element may represent the user's savings account number. In some embodiments, while or after the website loads, and as the screen reader is about to (or begins) interpreting the audio data of the fourth HTML element, a player (e.g., a customer player) associated with the browser module (or the server application or the website) may play the audio data of the fourth HTML element. Subsequently, the audio speaker may output the played audio data so that the user can hear the user's savings account number.

According to a further example of the disclosed subject matter, sensitive text data may be protected by converting it into a DRM package and displaying it through a DRM platform, which may create a gap for screen readers. By including either the audio or alt text in the DRM package, the needed data may be securely transferred to the end user. This data may be either in the subtitles, metadata, or audio channel of the DRM package. A user interface (hereinafter “UI”) may integrate either the text into the alt-text (e.g., where the screen reader expects it to be) or handle the audio file in a custom player that may be triggered at the appropriate time by the screen reader. The method may include 1) a user loading a page containing DRM-protected content; 2) the page containing DRM-protected content may load a website that may generate a video as well as an audio or text representation of the video and may combine these into a DRM package; 3) the DRM video may be played (e.g., as normal or expected); and 4a) the text may be loaded into the altText field of the video element on the page so that it may be read accurately when a screen reader gets to that element; or 4b) alternatively, the audio file may get played when the screen reader gets to the appropriate element.

The DRM may package and encrypt video, audio, or metadata. The video portion may be used to display the information on the screen, and the audio or metadata portion may be integrated with screen readers so that the user experience may not be degraded for individuals who are visually impaired.

While the examples above involve generating protected HTML to protect user account numbers, it should be understood that techniques according to this disclosure may be adapted to any suitable system, method, or configuration. For example, the techniques described herein may be adapted to protect any sensitive information, or information a user otherwise may not wish to share with a third party. It should also be understood that the examples above are illustrative only. The techniques and technologies of this disclosure may be adapted to any suitable activity. Presented below are various systems and methods of generating protected HTML.

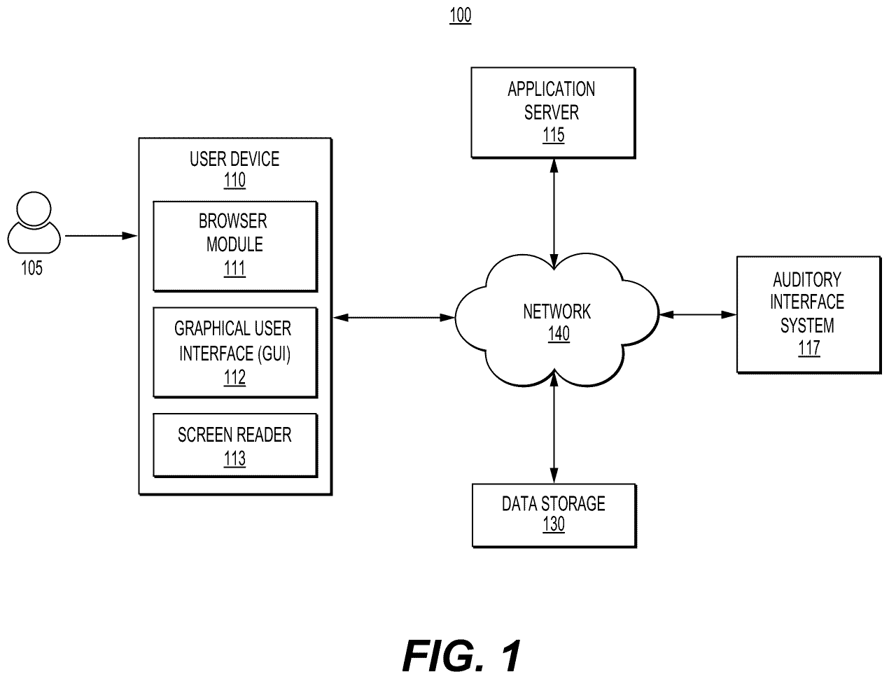

FIG. 1 depicts an example environment 100 that may be utilized with techniques presented herein. In some aspects, the environment 100 may be an embodiment of (i) environment 100 described in U.S. Provisional Application 63/587,891, filed on Oct. 4, 2023, (ii) environment 100 described in U.S. Provisional Application 63/665,485, filed on Jun. 28, 2024, or (iii) environment 100 described in U.S. Provisional Patent Application No. 63/683,063, filed Aug. 14, 2024 where each of these U.S. provisional applications is incorporated by reference herein in its entirety. FIG. 1 depicts an exemplary environment 100 for generating protected HTML, according to one or more embodiments. For example, aspects of the present disclosure relate to systems and methods for protecting one or more content elements (or data) displayed on a website (e.g., an account number, social security number, account balance values, etc.), where the protected one or more content elements may be read by a screen reader. In some aspects, the content element may represent sensitive or confidential information. The content element may also be included in a first HyperText Markup Language (HTML) element used to structure a website. For example, when a media content (e.g., a website) loads or is loaded, the first HTML element (which may be part of the HTML that structures the media content) may load or be loaded. If a content element is associated with the first HTML element, the content element may also load or be loaded.

Environment 100 may include one or more aspects that may communicate with each other over a network 140. In some embodiments, a user 105 may interact with a user device 110 such that protected accessible HTML may be generated. As depicted in FIG. 1, user device 110 may interact with at least one of an application server 115, an auditory interface system 117, or a data storage 130.

User device 110 may be configured to enable the user to access or interact with other systems in the environment 100. For example, user device 110 may be a computer system such as, for example, a desktop computer, a laptop computer, a tablet, a smart cellular phone, a smart watch or other electronic wearable, etc. In some embodiments, user device 110 may include one or more electronic applications, e.g., a program, plugin, browser extension, etc., installed on a memory of user device 110. In some embodiments, the electronic applications may be associated with one or more of the other components in the environment 100.

User device 110 may include a browser module 111, a graphical user interface (GUI) 112, or a screen reader 113. Browser module 111 may be configured to generate or transmit (e.g., to GUI 112) at least one of video data, text data, or audio data. Video data may include a video associated with the content element. Text data may include text associated with the content element. Audio data may include audio associated with the content element.

Screen reader 113 may be configured to convert text, HTML, etc. to a format readable by screen reader 113. For example, screen reader 113 may be configured to incorporate the text data of at least one of (i) a channel associated with metadata or (ii) a channel associated with subtitles into an alt text field of the third HTML element or an alt text field of an alt text tag of a document object model (“DOM”) associated with a media content (e.g., website). Further, screen reader 113 may be configured to convert text, HTML, etc. to audio that may be caused to be output (e.g., via speakers associated with user device 110 or auditory interface system 117).

User device 110 may obtain data from one or more aspects of environment 100, such as from GUI 112 (e.g., via one or more inputs from user 105), application server 115, data storage 130, etc. User device 110 may transmit data to one or more aspects of environment 100, e.g., application server 115, data storage 130, etc.

Application server 115 may be configured to generate DRM-protected video, text, or audio files or data. For example, application server 115 may be configured to generate DRM-protected files based on at least one of video data, text data, or audio data. It should be noted that in some embodiments, browser module 111 may be configured to generate the DRM-protected video, text, or audio files or data.

Application server 115 may be configured to detect interactions with the media content or the content element. It should be noted that in some embodiments, browser module 111 may be configured to detect interactions with the media content or the content element in lieu of, or in addition to, application server 115. For example, browser module 111 may be configured to receive a detection of a user interaction (e.g., from GUI 112), such as a selection, actuation, etc. The user input may be associated with the content element. For example, the user input may be actuation of an actuator (e.g., button, toggle, etc.) contained in the content element. In some embodiments, application server 115 may be configured to receive a request to load media content (e.g., a website), which may be associated with a first HTML element (e.g., the first HTML element may be part of the HTML of the media content). The first HTML element may include the content element (e.g., sensitive information such as an account number). In further embodiments of the present disclosure, application server 115 may be configured to receive an indication of whether the GUI (e.g., GUI 112) is being shared or recorded. In further embodiments of the present disclosure, application server 115 may be configured to detect initiation of an interpretation of the DRM-protected data of an HTML element. For example, GUI 112 may be configured to detect an interaction (e.g., a user input) which application server 115 may be configured to determine may indicate initiation of an interpretation (e.g., by screen reader 113) of the DRM-protected audio data of the fourth HTML element. In another example, GUI 112 may be configured to detect initiation of an interpretation (e.g., by screen reader 113) of the DRM-protected audio data of the fourth HTML element.

Application server 115 may be configured to generate HTML elements. Application server 115 may be configured to generate the HTML elements based on the one or more DRM-protected files or DRM-protected data. In some embodiments, application server 115 may be configured to generate a second HTML element, a third HTML element, or a fourth HTML element. The second HTML element may include DRM-protected video data associated with the content element. The third HTML element may include DRM-protected text data associated with the content element. The fourth HTML element may include DRM-protected audio data associated with the content element. It should be noted that in some embodiments, browser module 111 may be configured to generate the HTML elements.

In some embodiments, application server 115 may be configured to generate HTML elements based on at least one of HTML associated with the sensitive information or the DRM-protected files. For example, application server 115 may be configured to generate the second HTML element based on at least one of HTML associated with the sensitive information or the DRM-protected video data.

Further, application server 115 may be configured to generate a modified second HTML element. The modified second HTML element may include modified DRM-protected video data associated with the content element. For example, application server 115 may be configured to modify the second HTML element such that the DRM-protected video data may become substantially opaque or substantially transparent, such that the content element overlaid by the modified second HTML element may be substantially obscured or substantially visible, respectively. In some embodiments, application server 115 may be configured to generate the modified second HTML element in response to a determination of whether the GUI (e.g., GUI 112) is being shared or recorded, as discussed in further detail below.

Additionally, application server 115 may be configured to generate a nested HTML element. The nested HTML element may include a first HTML element and at least one of the second HTML element, the third HTML element, or the fourth HTML element. Application server 115 may be configured to generate the nested HTML element using methods described in further detail below.

Application server 115 may obtain data from one or more aspects of environment 100, e.g., from user device 110, auditory interface system 117, data storage 130, etc. Application server 115 may transmit data to one or more aspects of environment 100, e.g., to user device 110, auditory interface system 117, data storage 130, etc.

Auditory interface system 117 may be configured to cause to output DRM-protected audio data of the fourth HTML element. In some embodiments, auditory interface system 117 includes a speaker (e.g., an audio speaker). In some embodiments, auditory interface system 117 is incorporated into user device 110 (e.g., is built into user device 110). For example, auditory interface system 117 may be incorporated into screen reader 113 of user device 110. Auditory interface system 117 may obtain data from one or more aspects of environment 100, e.g., from user device 110, application server 115, data storage 130, etc. Auditory interface system 117 may transmit data to one or more aspects of environment 100, e.g., to user device 110, application server 115, data storage 130, etc.

Data storage 130 may be configured to receive for storage, store, retrieve from the storage, or transmit from the storage: video data, text data, audio data, DRM-protected data, DRM-protected files, HTML elements (e.g., the first HTML element, the second HTML element, the modified second HTML element, the third HTML element, the fourth HTML element, the nested HTML element, etc.), etc.

One or more of the components in FIG. 1 may communicate with each other or other systems, e.g., across network 140. In some embodiments, network 140 may connect one or more components of environment 100 via a wired connection, e.g., a USB connection between user device 110 and data storage 130. In some embodiments, network 140 may connect one or more aspects of environment 100 via an electronic network connection, for example a wide area network (WAN), a local area network (LAN), personal area network (PAN), a content delivery network (CDN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted or operated by a computer system so as to be accessible online, and that may include data configured to cause a program such as a web browser to perform operations such as send, receive, or process data, generate a visual display or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, auditory interface system 117 may be integrated in user device 110 or at least one aspect of user device 110, such as screen reader 113. In some embodiments, operations or aspects of one or more of the components discussed above may be distributed amongst one or more other components. In some embodiments, some of the components of environment 100 may be associated with a common entity, while others may be associated with a disparate entity. For example, application server 115 or auditory interface system 117 may be associated with a common entity (e.g., an entity with which user 105 has an account) while data storage may be associated with a third party (e.g., a provider of data storage services). Any suitable arrangement or integration of the various systems and devices of the environment 100 may be used.

Aspects of the present disclosure relate to systems and methods for protecting one or more content elements associated with media content (e.g., a website), where the protected one or more content elements may be read, e.g., by screen reader 113. For example, a system may comprise at least one memory storing instructions, and at least one processor operatively connected to the at least one memory and configured to execute the instructions to perform operations for protecting a content element. In some aspects, the content element may represent sensitive or confidential information (e.g., a savings account number). In some embodiments, the operations may further include forming, using the application server, one or more files including video data, audio data, or text data, where the one or more files may be protected by digital rights management (“DRM”) technologies.

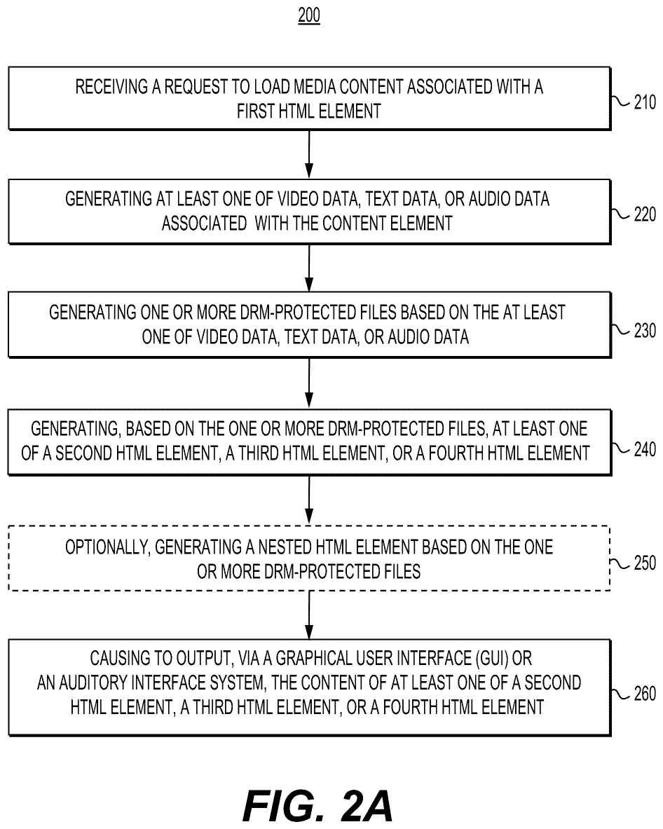

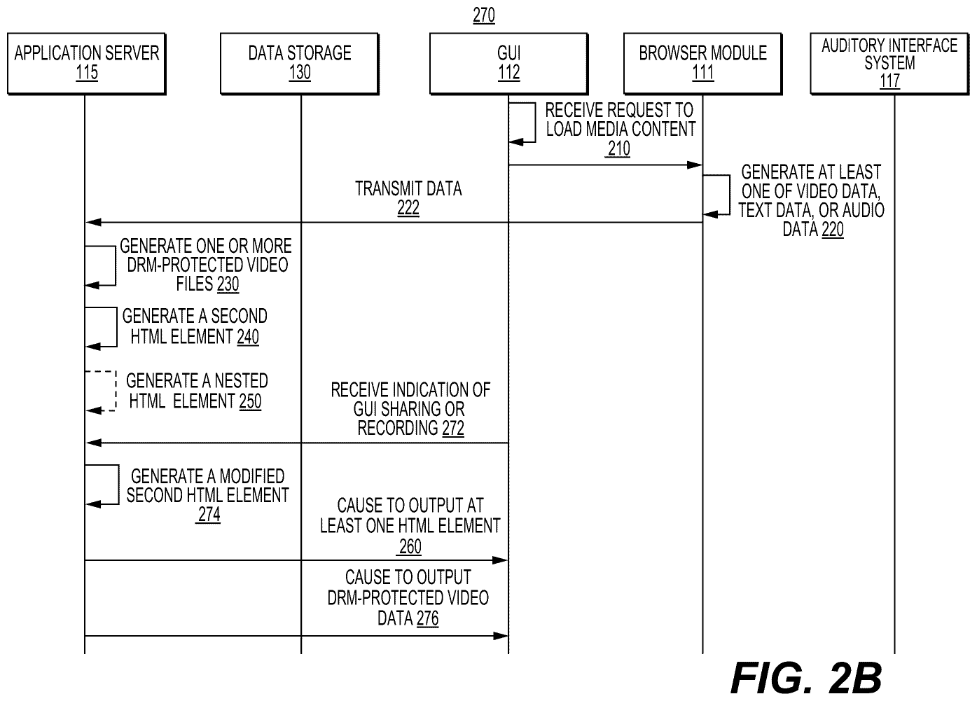

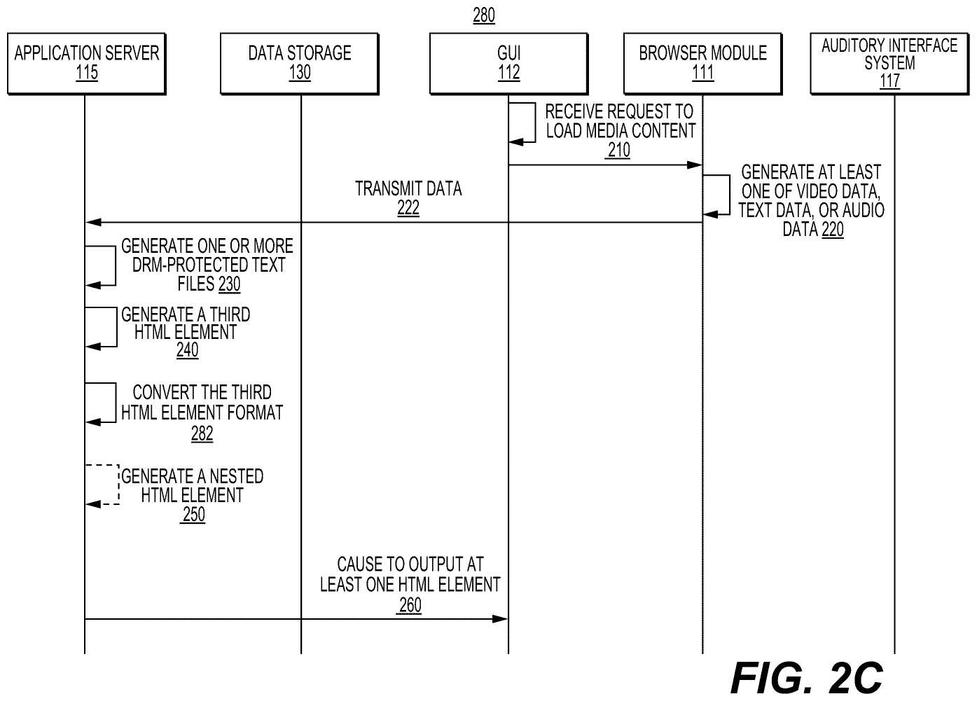

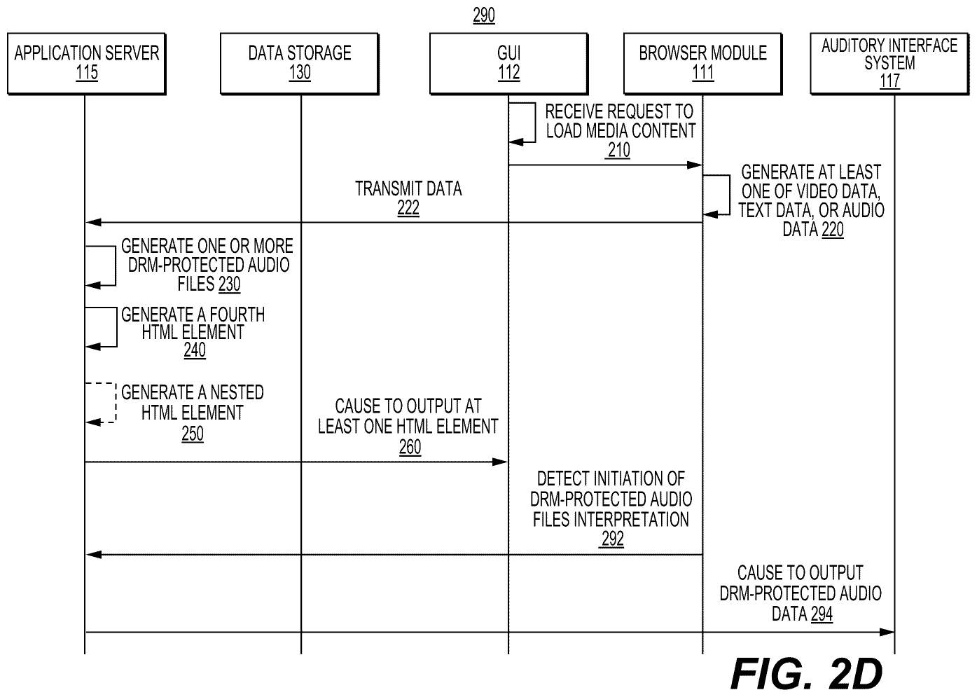

FIGS. 2A-2D depict an exemplary method for generating protected accessible HTML, according to one or more embodiments. FIG. 2A depicts an exemplary method 200 for generating protected accessible HTML, according to one or more embodiments. In some embodiments, exemplary method 200 may include operations including forming, using one of browser module 111, application server 115, auditory interface system 117, etc., one or more files including video data (e.g., a DRM package), audio data, or text data, where the one or more files may be protected by DRM technologies. The one or more files protected by DRM technologies may collectively be referred to herein as the “one or more DRM-protected files.” In some aspects, the DRM technologies may restrict the one or more DRM-protected files (or a portion of the data therein) from being shared or recorded (or captured) using at least one screen sharing application, remote desktop application, or screenshotting application.

At step 210, a request to load media content associated with a first HTML element may be received, e.g., via GUI 112. For example, user 105 may interact with GUI 112 of user device 110, e.g., by selecting a website that includes a savings account number for user 105.

At step 220, at least one of video data, text data, or audio data associated with the content element (e.g., based on the content element) may be generated. In some embodiments, the at least one of video data, text data, or audio data may be generated in response to the receipt of the request to load media content at step 210.

At step 230, one or more DRM-protected files may be generated, e.g., as a DRM package. The one or more DRM-protected files may be generated based on at least one of video data, text data, or audio data associated with the content element and generated at step 220.

At step 240, at least one HTML element may be generated, e.g., a second HTML element, a third HTML element, a fourth HTML element, etc. Discussed below are methods associated with generating each of the second HTML element, the third HTML element, and the fourth HTML element.

### The Second HTML Element: The Video Element

In some embodiments, a second HTML element may be generated based on the one or more DRM-protected files. As depicted in FIG. 2B, at least one of video data, text data, or audio data may be generated (step 220). The operations may include generating (e.g., via browser module 111, application server 115, etc.) video data associated with the content element (step 220). In some embodiments, the video may be generated in response to browser module 111 or application server 115 receiving a request to load (or display) media content (e.g., a website) on the display screen (e.g., GUI 112) of a computing device (step 210). At step 222, at least one of video data, text data, or audio data may be transmitted (e.g., to user device 110, application server 115, auditory interface system 117, data storage 130, etc.). For example, in the arrangement in which the video data is generated by the browser module 111, video data may be transmitted to application server 115. If, however, the video data was generated by the application server, the video data is not transmitted at step 222. At step 230, one or more DRM-protected video files may be generated, as discussed herein.

The operations may further include forming (e.g., using browser module 111 or application server 115) a second HTML element (step 240). The second HTML element may include a video of the one or more DRM-protected files.

The operations may further include causing to output the video of the second HTML element associated with the content element to a display screen (e.g., GUI 112) (steps 260, 276). In some aspects, the video of the second HTML element may be displayed on top of (e.g., overlaid on) the content element.

In some embodiments, the second HTML element may be modified (step 274). For example, an indication of whether a GUI (e.g., GUI 112) is being shared or recorded may be received (e.g., via browser module 111, application server 115, etc.) (step 272). In response to this indication, the second HTML element may be modified (step 274). For example, where the display screen (e.g., GUI 112) is not being electronically shared or recorded (or captured), the second HTML element may be modified such that the video may be played and appear as a transparent image or a transparent single frame-looped video on the display screen during the playing so that a person who views the display screen can view the content element presented under the video. Conversely, where the display screen (e.g., GUI 112) is being electronically shared or recorded, the second HTML element may be modified such that the DRM technologies (or protections) of the video may cause the video to stop playing and appear as an opaque image (e.g., a still image) that conceals the content element presented under the video. For example, where the video is a single frame-looped video, the video may be modified such that the video no longer loops, thereby displaying the single frame, which may appear as a still image. As a result, the DRM-protected video may protect the content element from being shared with or captured for a social engineer.

### The Third HTML Element: The Text Element

In some embodiments, a third HTML element may be generated based on the one or more DRM-protected files. As depicted in FIG. 2C, at least one of video data, text data, or audio data may be generated (step 220). The operations may include generating (e.g., via browser module 111, application server 115, etc.) text associated with the content element (step 220). In some embodiments, the text may be generated in response to browser module 111 or application server 115 receiving a request to load (or display) media content (e.g., a website) on the display screen (e.g., GUI 112) of a computing device (step 210). In some embodiments, the text data may represent a channel associated with metadata (also referred to herein as a “metadata channel”), or a channel associated with subtitles (also referred to herein as a “subtitle channel”). At step 222, at least one of video data, text data, or audio data may be transmitted (e.g., to user device 110, application server 115, auditory interface system 117, data storage 130, etc.). For example, in the arrangement in which the text data is generated by the browser module 111, text data may be transmitted to application server 115. If, however, the text data was generated by application server 115, the text data is not transmitted at step 222. At step 230, one or more DRM-protected text files may be generated, as discussed herein. In some embodiments, the operations may further include forming, using the browser module or the application server, a third HTML element including the text data of the one or more DRM-protected files (step 240). In some embodiments, the third HTML element may be configured to be read by screen reader 113. More specifically, the third HTML element may be formed (e.g., via browser module 111, application server 115, etc.) by incorporating the text data of the metadata channel or the subtitle channel in an alternate attribute text (“alt text”) field of an alt text tag of, for example, a document object model (“DOM”) associated with the media content (e.g., website) (step 282). In some aspects, the third HTML element may represent alt text (e.g., text configured to be identified and interpreted by screen reader 113) and may be DRM-protected. Further, in some embodiments, the third HTML element may be included (e.g., nested) in the first HTML element, as discussed in further detail below (step 250).

In some embodiments, the operations may include causing to output (e.g., using browser module browser module 111, application server 115, screen reader 113, etc.) the text data of the one or more files, e.g., to a braille display associated with GUI 112) (step 260).

### The Fourth HTML Element: The Audio Element

In some embodiments, a fourth HTML element may be generated based on the one or more DRM-protected files. As depicted in FIG. 2D, at least one of video data, text data, or audio data may be generated (step 220). The operations may include generating (e.g., via browser module 111, application server 115, auditory interface system 117, etc.) audio associated with the content element (step 220). The audio data may represent a channel associated with audio (also referred to herein as an “audio channel”). In some embodiments, the audio may be generated in response to receipt of a request (e.g., via browser module 111, application server 115, auditory interface system 117, etc.) to load (or display) media content (e.g., a website) on the display screen (e.g., GUI 112) of a computing device (step 210). At step 222, at least one of video data, text data, or audio data may be transmitted (e.g., to user device 110, application server 115, auditory interface system 117, data storage 130, etc.). For example, in the arrangement in which the audio data is generated by the browser module 111, audio data may be transmitted to application server 115. If, however, the audio data was generated by application server 115, the audio data is not transmitted at step 222. At step 230, one or more DRM-protected audio files may be generated, as discussed herein.

In some embodiments, the operations may include forming (e.g., via browser module 111, application server 115, auditory interface system 117, etc.) a fourth HTML element (step 240). The fourth HTML element may include the audio data of the one or more DRM-protected files. In some embodiments, the fourth HTML element may be included (e.g., nested) with the first HTML element, as discussed in further detail below (step 250).

The fourth HTML element or the DRM-protected audio data may be caused to be output (e.g., via browser module 111, application server 115, auditory interface system 117, etc.), and be played using an audio speaker associated with GUI 112 or auditory interface system 117 (steps 260, 294). In some embodiments, the fourth HTML element or the DRM-protected audio data may be caused to be output (steps 260, 294) in response to detection of initiation of the interpretation of the DRM-protected files (e.g., including the DRM-protected audio data) (step 292). In some embodiments, deployment of screen reader 113 may initiate the interpretation of the DRM-protected audio files. Accordingly, because environment 100 is configured to operate with screen reader 113, a user of screen reader 113 (e.g., a person who is visually impaired or illiterate) (e.g., user 105) may use the system to access sensitive or confidential information on the website while being protected from social engineering.

Returning to FIG. 2A, optionally, at step 250, a nested HTML element may be generated (e.g., via browser module 111, application server 115, auditory interface system 117, etc.). In some embodiments, the nested HTML element may be generated to include the first HTML element and at least one of the second HTML element, the third HTML element, or the fourth HTML element.

At step 260, at least one HTML element (e.g., the first HTML element, the second HTML element, the modified second HTML element, the third HTML element, the fourth HTML element, etc.) or the nested HTML element may be caused to be outputted.

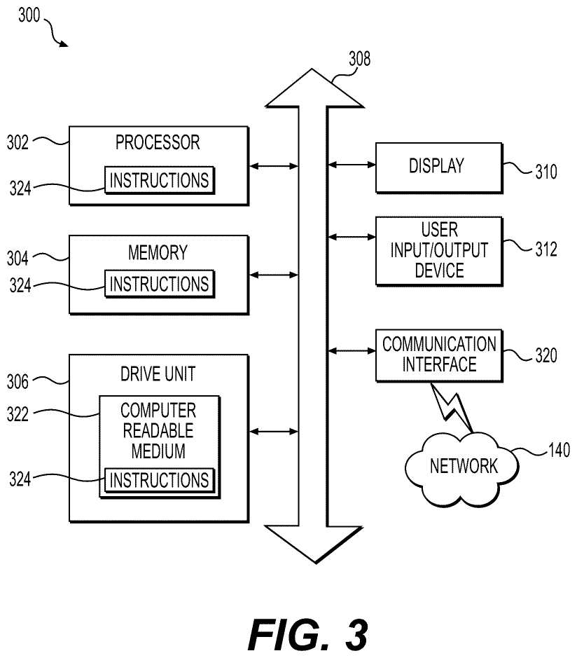

FIG. 3 depicts a simplified functional block diagram of a computer 300 that may be configured as a device for executing the methods disclosed here, according to exemplary embodiments of the present disclosure. For example, the computer 300 may be configured as a system according to exemplary embodiments of this disclosure. In various embodiments, any of the systems herein may be a computer 300 including, for example, a data communication interface 320 for packet data communication. The computer 300 also may include a central processing unit (CPU) 302, in the form of one or more processors, for executing program instructions. The computer 300 may include an internal communication bus 308, and a storage unit 306 (such as ROM, HDD, SDD, etc.) that may store data on a computer readable medium 322, although the computer 300 may receive programming and data via network communications. The computer 300 may also have a memory 304 (such as RAM) storing instructions 324 for executing techniques presented herein, although the instructions 324 may be stored temporarily or permanently within other modules of computer 300 (e.g., processor 302 or computer readable medium 322). The computer 300 also may include input and output ports 312 or a display 310 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for generating protected accessible HyperText Markup Language (“HTML”), the method comprising:
receiving a request to load media content associated with a first HTML element, the first HTML element including a content element;
upon receiving the request to load the content element, generating video data associated with the content element;
generating one or more digital rights management (“DRM”)-protected files based on the video data associated with the content element, wherein at least one of the one or more DRM-protected files includes the video data associated with the content element;
generating a second HTML element based on the one or more DRM-protected files, wherein the second HTML element includes DRM-protected video data associated with the content element; and
causing to output, via a graphical user interface (“GUI”), the DRM-protected video data of the second HTML element.

2. The method of claim 1, wherein the second HTML element is outputted such that the second HTML element is overlaid on the content element.

3. The method of claim 2, further comprising:
converting the video data of the second HTML element to be substantially opaque such that the content element is substantially obscured.

4. The method of claim 3, wherein converting the second HTML element to be substantially opaque further comprises:
converting the second HTML element to a substantially opaque still image.

5. The method of claim 1, further comprising:
upon receiving the request to load the content element, generating text data associated with the content element;
generating the one or more DRM-protected files based on the text data associated with the content element, wherein at least one of the one or more DRM-protected files includes the text data associated with the content element;
generating a third HTML element based on the one or more DRM-protected files, wherein the third HTML element includes DRM-protected text data associated with the content element; and
causing to output, via the GUI, the DRM-protected text data of the third HTML element.

6. The method of claim 5, wherein the text data represents at least one of a channel associated with metadata, a channel associated with subtitles, or a channel associated with alternate attribute text (“alt text”).

7. The method of claim 5, further comprising:
converting the third HTML element into a format configured to be read by a screen reader; and
causing to output, via a screen reader, the converted third HTML element.

8. The method of claim 7, wherein converting the third HTML element into the format configured to be read by the screen reader further comprises:
incorporating the text data of at least one of a channel associated with metadata or a channel associated with subtitles into an alt text field of the third HTML element or an alt text field of an alt text tag of a document object model (“DOM”) associated with the media content.

9. The method of claim 1, further comprising:
upon receiving the request to load the content element, generating audio data associated with the content element;
generating the one or more DRM-protected files based on the audio data associated with the content element, wherein at least one of the one or more DRM-protected files includes the audio data associated with the content element;
generating a fourth HTML element based on the one or more DRM-protected files, wherein the fourth HTML element includes DRM-protected audio data associated with the content element; and
causing to output, via the GUI, the DRM-protected audio data of the fourth HTML element.

10. The method of claim 1, further comprising:
generating audio data associated with the content element;
generating the one or more DRM-protected files based on the audio data associated with the content element, wherein at least one of the one or more DRM-protected files includes the audio data associated with the content element;
storing, via a data storage system, the audio data and the one or more DRM-protected files;
upon receiving the request to load the content element, generating a fourth HTML element based on the one or more DRM-protected files, wherein the fourth HTML element includes DRM-protected audio data associated with the content element; and
causing to output, via the GUI, the DRM-protected audio data of the fourth HTML element.

11. The method of claim 10, further comprising:
detecting initiation of an interpretation of the DRM-protected audio data of the fourth HTML element; and
causing to output, via an auditory interface system, the DRM-protected audio data of the fourth HTML element.

12. The method of claim 1, further comprising:
generating a nested HTML element based on the one or more DRM-protected files, wherein the nested HTML element includes the first HTML element and at least one of the second HTML element, a third HTML element, or a fourth HTML element, wherein:
the third HTML element includes DRM-protected text data associated with the content element, and
the fourth HTML element includes DRM-protected audio data associated with the content element; and
causing to output, via a GUI, DRM-protected data of the nested HTML element.

13. A system, the system comprising:
at least one memory storing instructions; and
at least one processor operatively connected to the memory, and configured to execute the instructions to perform operations for generating protected accessible HTML, the operations including:
receiving a request to load media content associated with a first HTML element, the first HTML element including a content element;
upon receiving the request to load the content element, generating video data associated with the content element;
generating one or more DRM-protected files based on the video data associated with the content element, wherein at least one of the one or more DRM-protected files includes the video data associated with the content element;
generating a second HTML element based on the one or more DRM-protected files, wherein the second HTML element includes DRM-protected video data associated with the content element; and
causing to output, via a GUI, the DRM-protected video data of the second HTML element.

14. The system of claim 13, the operations further including:
converting the second HTML element to be substantially opaque such that the content element is substantially obscured; and
causing to output, via a GUI, the substantially opaque second HTML element such that the second HTML element is overlaid on the content element.

15. The system of claim 13, the operations further including:
upon receiving the request to load the content element, generating text data associated with the content element;
generating the one or more DRM-protected files based on the text data associated with the content element, wherein at least one of the one or more DRM-protected files includes the text data associated with the content element,
wherein the text data represents at least one of a channel associated with metadata, a channel associated with subtitles, or a channel associated with alternate attribute text (“alt text”);
generating a third HTML element based on the one or more DRM-protected files, wherein the third HTML element includes DRM-protected text data associated with the content element; and
causing to output, via the GUI, the DRM-protected text data of the third HTML element.

16. The system of claim 13, the operations further comprising:
generating audio data associated with the content element;
generating the one or more DRM-protected files based on the audio data associated with the content element, wherein at least one of the one or more DRM-protected files includes the audio data associated with the content element;
storing, via a data storage system, the audio data and the one or more DRM-protected files;
upon receiving the request to load the content element, generating a fourth HTML element based on the one or more DRM-protected files, wherein the fourth HTML element includes DRM-protected audio data associated with the content element; and
causing to output, via the GUI, the DRM-protected audio data of the fourth HTML element.

17. The system of claim 15, the operations further including:
converting the third HTML element into a format configured to be read by a screen reader by incorporating the DRM-protected text data of at least one of the channel associated with metadata or the channel associated with subtitles into an alt text field of the third HTML element or an alt text field of an alt text tag of a DOM associated with the media content; and
causing to output, via a GUI, the converted third HTML element.

18. The system of claim 13, the operations further including:
upon receiving the request to load the content element, generating audio data associated with the content element;
generating the one or more DRM-protected files based on the audio data associated with the content element, wherein at least one of the one or more DRM-protected files includes the audio data associated with the content element;
generating a fourth HTML element based on the one or more DRM-protected files, wherein the fourth HTML element includes DRM-protected audio data associated with the content element; and
causing to output, via an auditory interface system, the DRM-protected audio data of the fourth HTML element.

19. The system of claim 13, the operations further including:
generating a nested HTML element based on the one or more DRM-protected files, wherein the nested HTML element includes the first HTML element and at least one of the second HTML element, a third HTML element, or a fourth HTML element, wherein:
the third HTML element includes DRM-protected text data associated with the content element, and
the fourth HTML element includes DRM-protected audio data associated with the content element; and
causing to output, via a GUI or an auditory interface system, the DRM-protected data of the nested HTML element.

20. A method for generating protected accessible HTML, the method comprising:
receiving a request to load media content associated with a first HTML element, the first HTML element including a content element;
upon receiving the request to load the content element, generating at least one of video data, text data, or audio data associated with the content element;
generating one or more DRM-protected files based on the at least one of video data, text data, or audio data associated with the content element, wherein at least one of the one or more DRM-protected files includes the at least one of video data, text data, or audio data associated with the content element;
generating a second HTML element based on the one or more DRM-protected files, wherein the second HTML element includes DRM-protected video data associated with the content element;
generating a third HTML element based on the one or more DRM-protected files, wherein the third HTML element includes DRM-protected text data associated with the content element;
generating a fourth HTML element based on the one or more DRM-protected files, wherein the fourth HTML element includes DRM-protected audio data associated with the content element;
generating a nested HTML element based on the one or more DRM-protected files, wherein the nested HTML element includes the first HTML element and at least one of the second HTML element, the third HTML element, or the fourth HTML element; and
causing to output, via a GUI or an auditory interface system, the DRM-protected data of the nested HTML element.
